(19) United States
(12) Patent Application Publication
(10) Pub. No.: US 2018/0022205 A1
(43) Pub. Date: Jan. 25, 2018

(54) METHOD FOR CONTROLLING A VARIABLE-SPEED TRANSMISSION DEVICE WITH EPICYCLIC GEAR TRAINS OF A POWER TRAIN, IN PARTICULAR FOR A HYBRID VEHICLE

(71) Applicant: IFP Energies nouvelles, RUEIL-MALMASION CEDEX (FR)

(72) Inventor: Stephane VENTURI, ROIFFIEUX (FR)

(21) Appl. No.: 15/547,423

(22) PCT Filed: Jan. 13, 2016
(86) PCT No.: PCT/EP2016/050532

§ 371 Date: Jul. 28, 2017

(30) Foreign Application Priority Data
Jan. 30, 2015 (FR) 1550722

(51) Int. Cl. B60K 6/48; B60K 6/365; F16H 3/72

(52) U.S. Cl. CPC B60K 6/48; F16H 3/725; B60K 6/365; F16H 2200/2007; F16H 2200/2035; F16H 2200/2069; F16H 2200/2084; B60K 2006/4816; B60Y 2200/92; Y10S 903/911

(57) ABSTRACT

The present invention relates to a method of controlling a variable-speed transmission device of a powertrain, in particular for a hybrid vehicle, comprising a driving/receiving machine (20), a thermal engine (10), a speed variation device (14) including an engine epicyclic gear train (24) with a sun gear (34) and a crown (46), each connected to engine shaft (12) by a controlled coupling (26, 28) and to a fixed part (44) of the powertrain by a one-way automatic coupling (30, 32) and a planet gear carrier (52), and a machine epicyclic gear train (68) arranged on a shaft (70) substantially parallel to engine shaft (12) and connecting engine epicyclic gear train (24) to a track (94, 96) for motion transmission to a drive axle (16), said gear train comprising a sun gear (72), a crown (86) and a planet gear carrier (78).

According to the invention, the method consists in blocking sun gear (72) and crown (86) of machine epicyclic gear train (68) to provide motion of the vehicle by machine (20) alone or in combination with engine (10).

### FIELD OF THE INVENTION

The present invention relates to a method of controlling a variable-speed transmission device of a powertrain, in particular for a hybrid vehicle.

As it is already known, a hybrid vehicle comprises a powertrain that uses, alone or in combination, as a traction/propulsion drive means, an internal-combustion thermal engine with a variable-speed transmission device and/or a driving/receiving machine, like a rotary electric machine connected to an electric source, such as one or more batteries.

This combination advantageously allows to optimize the performances of this vehicle, notably by reducing the discharge of emissions to the atmosphere as well as the fuel consumption.

Thus, when the vehicle is to be driven with a high torque over a wide speed range while limiting exhaust gas and noise generation, as in an urban site, the electric machine is preferably used for driving this vehicle.

On the other hand, the thermal engine is used for driving this vehicle for uses where a high driving power and a wide operating range are required.

### BACKGROUND OF THE INVENTION

As is already known from French patent application No. 2,955,165 filed by the applicant, such an automotive vehicle powertrain comprises a thermal engine with a shaft connected to a variable-speed transmission device including an engine epicyclic gear train with a sun gear and a crown connected each to the thermal engine shaft by a controlled coupling and to a fixed part of the powertrain by a one-way automatic coupling, and a planet gear carrier transmitting the speed variation to the drive axle of the vehicle through a transmission track.

In order to increase the speed variation capacity when the vehicle is driven on the electric machine, the applicant has combined the variable-speed transmission device of the aforementioned document with another epicyclic gear train connecting the engine epicyclic gear train to the track for motion transmission to the drive axle of this vehicle, as described in French patent application No. 2,962,697 filed by the applicant.

The applicant has further improved this transmission device notably by reducing the size thereof, more particularly the other epicyclic gear train while providing simple and effective control of this transmission.

### SUMMARY OF THE INVENTION

The invention therefore relates to a method of controlling a variable-speed transmission device of a powertrain, in particular for a hybrid vehicle, comprising a driving/receiving machine, a thermal engine, a speed variation device including an engine epicyclic gear train with a sun gear and a crown, each connected to the engine shaft by a controlled coupling and to a fixed part of the powertrain by a one-way automatic coupling and a planet gear carrier, and a machine epicyclic gear train arranged on a shaft substantially parallel to the engine shaft and connecting the engine epicyclic gear train to a track for motion transmission to a drive axle, said gear train comprising a sun gear, a crown and a planet gear carrier, characterized in that it consists in blocking the sun gear and the crown of the machine epicyclic gear train to provide motion of the vehicle by means of the machine alone or in combination with the engine.

The method can consist in providing a controlled coupling between the crown and the sun gear.

The method can consist in providing a controlled coupling on the crown shaft.

The method can consist in providing a controlled coupling on the toothed strip of the crown.

The method can consist in providing a coupling surface on the sun gear.

The method can consist in providing a coupling surface on a web carried by the sun gear.

### BRIEF DESCRIPTION OF THE FIGURES

Other features and advantages of the invention will be clear from reading the description hereafter, given by way of non limitative example, with reference to the accompanying figures wherein:

FIG. 1 is a diagram showing a variable-speed transmission device of a powertrain according to the invention, and

FIG. 2 diagrammatically illustrates a variant of FIG. 1.

### DETAILED DESCRIPTION

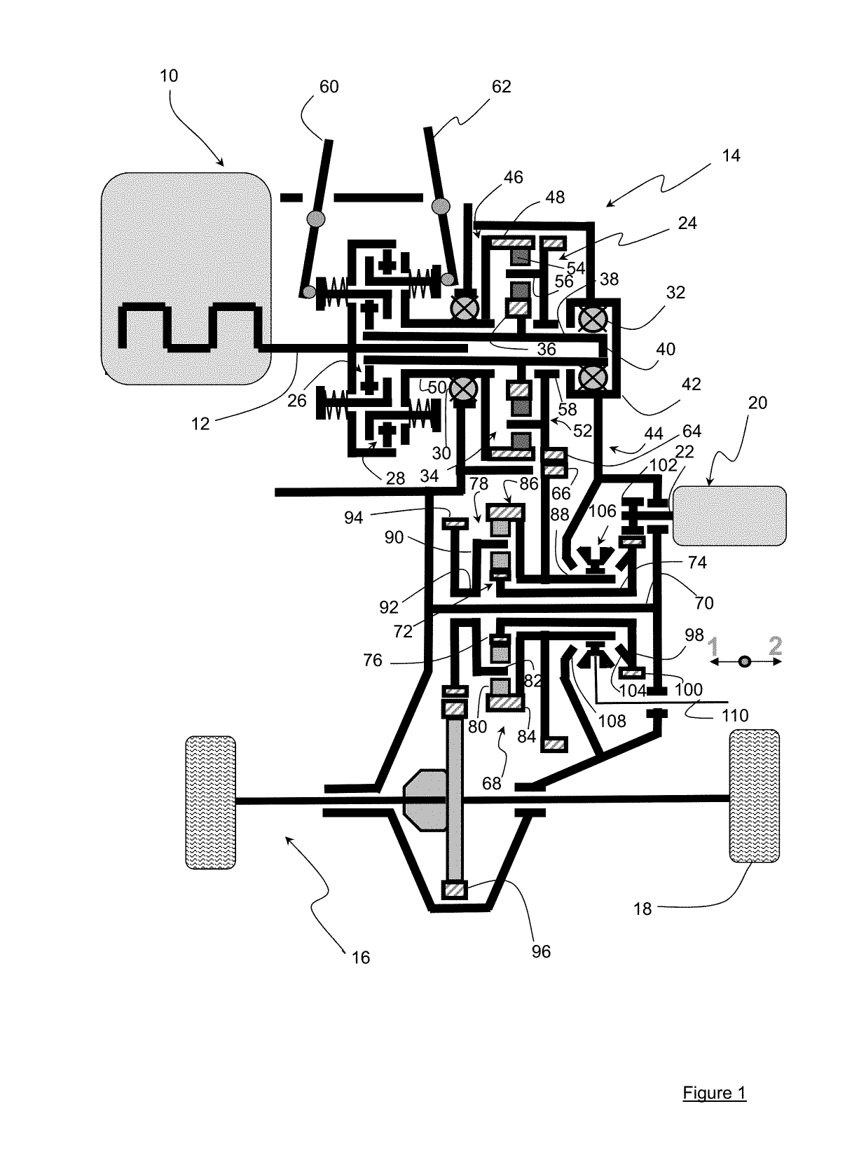

In FIG. 1, the powertrain comprises a thermal engine 10, notably an internal-combustion engine, with an engine shaft 12, coming from the crankshaft of this engine here, a variable-speed transmission device 14 and a drive axle 16 allowing to drive driving wheels 18 of the vehicle.

The powertrain also comprises a driving/receiving machine such as an electric motor 20 with a rotor 22 that can operate either as an electric motor for driving the vehicle by being connected to an electric current source, such as batteries (not shown), or as an electric power generator and more particularly as an alternator for charging these batteries.

Speed variation device 14 comprises a main epicyclic gear train 24, referred to as engine epicyclic gear train, with two controlled couplings 26, 28, here in form of friction clutches, and two one-way automatic couplings, such as free wheels 30, 32.

More precisely, engine epicyclic gear train 24 comprises a sun gear 34 with an externally toothed strip 36, carried by a hollow shaft 38, referred to as sun gear shaft, which tops engine shaft 12 while being free in rotation but fixed in translation with respect thereto. Free end 40 of this shaft rests against a bearing 42 carried by a fixed part 44 of the powertrain through free wheel 32, referred to as sun gear free wheel, which allows rotation of the sun gear in one direction only.

This gear train also comprises a crown 46 with an internally toothed strip 48 arranged concentrically to the sun gear, and connected to a hollow shaft 50, referred to as crown shaft, surrounding sun gear hollow shaft 38 while being free in rotation, but fixed in translation with respect thereto. This crown is externally connected to fixed part 44 of the vehicle powertrain by one-way coupling 30, referred to as crown free wheel, which allows rotation of the crown in one direction only.

Of course, the two free wheels 30 and 32 are arranged in such a way that sun gear 34 and crown 46 can rotate only in the same direction, and preferably in the same direction as engine shaft 12.

Finally, this engine epicyclic gear train comprises a planet gear carrier 52 with advantageously three planet gears 54 in form of externally toothed wheels, arranged in the same angular interval with respect to one another (120° here) and meshing with the crown and the sun gear.

Crown strip 48, sun gear strip 36 and planet gears 54 are therefore arranged in the same plane, here in a vertical plane considering FIG. 1.

These planet gears are carried each by a horizontal pin 56 while being free in rotation, but fixed in translation thereon. These planet gear pins are connected to a tubular bearing 58, referred to as planet gear carrier bearing, surrounding sun gear shaft 38 while rotating freely thereon.

The free ends of the sun gear and crown shafts carry each a controlled coupling 26 and 28, preferably a friction clutch controlled each by a lever control 60 and 62.

Thus, clutch 26, referred to as sun gear clutch, allows to couple the sun gear with engine shaft 12, while the purpose of clutch 28, referred to as crown clutch, is to couple the crown with this engine shaft.

As is better visible in FIG. 1, planet gear carrier 52 also comprises an additional externally toothed strip 64 arranged opposite the planet gears, which is connected by meshing with an externally toothed linking strip 66 of another additional epicyclic gear train 68, referred to as machine epicyclic gear train.

This epicyclic gear train 68 is arranged on a fixed shaft 70 substantially parallel to engine shaft 12.

The machine epicyclic gear train comprises a sun gear 72 rotatingly connected to a tubular shaft 74 that surrounds fixed shaft 70 and comprises an externally toothed strip 76 carried by a flange.

This sun gear cooperates with a planet gear carrier 78 comprising advantageously three planet gears 80, in form of externally toothed wheels, carried by planet gear pins 82 and arranged in the same angular interval with respect to one another (120° here), and meshing with the teeth of drive strip 84 of crown 86 of the machine epicyclic gear train.

This crown is carried by a tubular shaft 88 surrounding sun gear shaft 74.

Of course, as for engine epicyclic gear train 24, the crown strip, the sun gear toothed strip and the planet gears are arranged in the same plane, here a vertical plane considering FIG. 1.

As can be better seen in the figure, planet gear pins 82 are carried by a web 90 fastened to a tubular bearing 92 surrounding fixed shaft 70.

This tubular bearing also carries an externally toothed strip 94 that cooperates with another toothed wheel 96 linked to drive axle 16, thus forming a motion transmission track between machine epicyclic gear train 68 and axle 16.

Considering the right part of FIG. 1, sun gear tubular shaft 74 fixedly carries a web 98 with a toothed wheel 100 that cooperates with rotor 22 of machine 20, here through the agency of a toothed wheel 102.

Web 98 also carries a coupling surface 104 that cooperates with a controlled coupling 106 carried by tubular crown shaft 88.

This coupling thus allows to connect the crown shaft either to web 98 and therefore to rotor 22 of machine 20 and to sun gear shaft 74, or to a fixed coupling surface 108 carried by fixed part 44 of the powertrain.

Advantageously, this coupling comprises a double-acting synchromesh, referred to as machine synchromesh, with two coupling positions and a neutral position. This synchromesh is fixedly carried in rotation but freely in translation by tubular crown shaft 88 and it is intended to cooperate, under the action of a control means 110, with either coupling surface 104 of web 98, or with fixed part 44 of the powertrain through surface 108.

The various configurations of the powertrain assembly are now described, by way of example, when machine 20 is used as the driving machine.

Both clutches 26 and 28 are therefore inactive and control means 110 is actuated so as to control the motion of the synchromesh towards position 2.

In this position, synchromesh 106 is in gear with coupling surface 104 carried by web 90, which has the effect of blocking crown 98 with sun gear 72.

Upon rotation of machine 20, the rotation of its rotor 22 is retransmitted to the assembly consisting of crown 86 and sun gear 72 through toothed wheels 100 and 102.

The rotation of this assembly is then transmitted to planet gear carrier 78 whose rotation drives externally toothed strip 94 to rotate. This rotation of the strip is retransmitted to toothed wheel 96 linked to drive axle 16.

In this configuration, the vehicle is driven to move only under the effect of the electric motor torque (electric mode).

This operating mode can be enhanced by a power supplement provided by engine 10 through epicyclic gear train 24 (parallel hybrid mode) while maintaining synchromesh 106 in position 2.

Thus, in the configuration where both clutches 26 and 28 are in active position under the action of levers 60 and 62, the rotation of shaft 12 of thermal engine 10 drives crown 46, sun gear 34 and therefore planet gear carrier 52 of engine epicyclic gear train 24 to rotate. This rotation of the planet gear carrier is then transmitted to tubular shaft 88 of crown 74 of the other epicyclic gear train through strips 64 and 66.

The torque generated at the planet gear carrier of the engine epicyclic gear train thus adds up on tubular shaft 88 to the torque transmitted by electric motor 20.

In the inactive position of clutch 26 and the active position of clutch 28, the rotation of shaft 12 of thermal engine 10 drives crown 46 to rotate, which drives planet gear carrier 52 to rotate, while the rotation of sun gear shaft 38 is blocked by free wheel 32. This rotation of the planet gear carrier is then transmitted to tubular shaft 88 of crown 74 of machine epicyclic gear train 68 through the cooperation of strips 64 and 66.

Similarly, the torque generated at the planet gear carrier of the engine epicyclic gear train thus adds up on tubular shaft 88 to the torque transmitted by the electric motor, with this specific feature that the torque transmitted to tubular shaft 88 of the machine epicyclic gear train is different from the one where clutches 26 and 28 are in active position.

In the inactive position of clutch 28 and the active position of clutch 26, the rotation of shaft 12 of thermal engine 10 drives sun gear 34 to rotate while the rotation of crown shaft 50 is blocked by free wheel 30. The rotation of the sun gear drives planet gear carrier 52 of gear train 24, then tubular shaft 88 of crown 74 of machine epicyclic gear train 68 to rotate.

As mentioned above, the torque generated at the planet gear carrier of the engine epicyclic gear train thus adds up on tubular shaft 88 to the torque transmitted by the electric motor. In this configuration, the torque transmitted to tubular shaft 88 of the machine epicyclic gear train is different from the one where clutches 26 and 28 are in active position and the one where clutch 26 is inactive and clutch 28 is active.

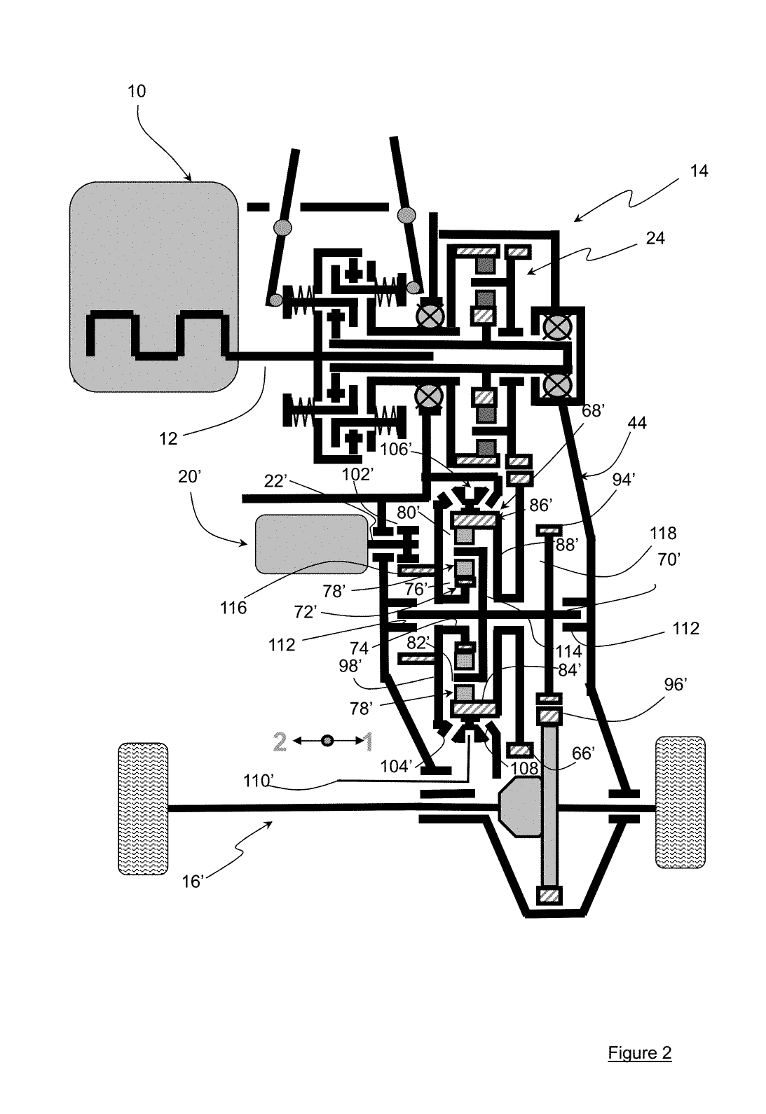

The variant of FIG. 2 differs from the example of FIG. 1 only in a specific configuration of the machine epicyclic gear train.

This epicyclic gear train 68′ is arranged on a fixed shaft 70′, free in rotation but fixed in translation and substantially parallel to engine shaft 12, while being carried by two bearings 112 provided on fixed element 44 of the powertrain.

This machine epicyclic gear train comprises a crown 86′ carried by a crown shaft 88′ surrounding shaft 70′ and carrying linking strip 66′.

The gear train also comprises a planet gear carrier 78′ with advantageously three planet gears 80′ carried by planet gear pins 82′ and meshing with the teeth of strip 84′ of crown 86′.

Planet gear pins 82′ are carried by a plate 114 directly connected to shaft 70′.

The planet gears also cooperate by meshing with a sun gear 72′ that comprises an externally toothed strip 76′ carried by a flange that is fixedly mounted on sun gear shaft 74′ surrounding shaft 70′.

Sun gear shaft 74′ carries a web 98′ provided with a toothed strip 116 cooperating with toothed wheel 102′ of rotor 22′ of machine 20′. This web also comprises a coupling surface 104′ that cooperates with a controlled coupling 106′ carried by toothed strip 84′ of crown 86′.

This coupling thus allows to connect the crown either to web 98′ and therefore to rotor 22′ of machine 20′ and to sun gear shaft 74′, or to a fixed coupling surface 108′ carried by fixed part 44 of the powertrain.

As in FIG. 1, this coupling advantageously comprises a double-acting synchromesh, referred to as machine synchromesh, with two coupling positions and a neutral position. This synchromesh is carried fixedly in rotation but freely in translation by crown 86′ and it is intended to cooperate, under the effect of a control means 110′, either with coupling surface 104′ of web 98′ (position 2), or with fixed part 44 of the powertrain (position 1) through surface 108′.

Shaft 70′ also carries a toothed strip 94′ carried by a fixed web 118 on this shaft. This strip cooperates with another toothed wheel 96′ connected to drive axle 16′, thus forming a motion transmission track between machine epicyclic gear train 68 and axle 16.

As already described in connection with FIG. 1, this variant comprises the same operating modes: electric mode or parallel hybrid mode.

This variant thus allows to have a layout of machine 20 and transmission track 94, 96 that can be used depending on the vehicle layouts.

1. A method of controlling a variable-speed transmission device of a powertrain, in particular for a hybrid vehicle, comprising a driving/receiving machine, a thermal engine, a speed variation device including an engine epicyclic gear train with a sun gear and a crown, each connected to engine shaft by a controlled coupling and to a fixed part of the powertrain by a one-way automatic coupling and a planet gear carrier, and a machine epicyclic gear train arranged on a shaft substantially parallel to the engine shaft and connecting engine epicyclic gear train to a track for motion transmission to a drive axle, said gear train comprising a sun gear, a crown and a planet gear carrier, the method comprising blocking the sun gear and the crown of the machine epicyclic gear train to provide motion of the vehicle by means of the driving/receiving machine alone or in combination with the thermal engine.

2. A control method according to claim 1, comprising providing a controlled coupling between the crown and the sun gear.

3. A control method according to claim 1comprising providing a controlled coupling on the crown shaft.

4. A control method according to claim 1comprising providing a controlled coupling on a toothed strip of the crown.

5. A control method according to claim 1, comprising providing a coupling surface on the sun gear.

6. A control method according to claim 1, comprising providing a coupling surface on a web carried by the sun gear.
